(19) United States
(12) Patent Application Publication
(10) Pub. No.: US 2015/0046212 A1
(43) Pub. Date: Feb. 12, 2015

(54) MONITORING OF BUSINESS PROCESSES AND SERVICES USING CONCEPT PROBES AND BUSINESS PROCESS PROBES

(71) Applicant: XEROX CORPORATION, Norwalk, CT (US)

(72) Inventor: Adrian C. Mos, Meylan (FR)

(73) Assignee: XEROX CORPORATION, Norwalk, CT (US)

(21) Appl. No.: 13/963,240

(22) Filed: Aug. 9, 2013

(51) Int. Cl. G06Q 10/06

(52) U.S. Cl. CPC G06Q 10/0633
USPC 705/7.27

(57) ABSTRACT

A computer-implemented business process monitoring system and method are disclosed. The business process runs in a Business Process Management Suite (BPMS) having a BPMS monitoring component. The activities of the business process communicate with services running in a Service Oriented Architecture (SOA) having an SOA monitoring component. The system includes memory which stores a concept probe and optionally a business process probe. The concept probe receives information from the BPMS monitoring component and the SOA monitoring component about activities associated with the concept probe and aggregates the information, generating alerts. The business process probe receives information from the concept probes and the BPMS and aggregates the data, generating alerts.

### BACKGROUND

The exemplary embodiment relates to monitoring of business processes and business activities and their associated services in a service-oriented environment.

Business Process Management (BPM) and Service Oriented Architectures (SOA) are two significant aspects of business enterprise solutions. BPM addresses the methodology and tools that enable the management of business processes (BPs) as they evolve throughout their lifecycles. A Business Process Management Suite (BPMS) executes business processes and connects them to various enterprise resources, such as a personnel directory, various legacy applications, and, in some cases, to the organization's SOA. An enterprise SOA typically manages the reusable technical services used to execute tasks that occur in business processes. Their functionality, granularity, and interfaces define their level of reuse across a multitude of business processes. In general, the closer the SOA services match the business requirements, the faster it is to implement new business processes.

Business processes (BPs) are often modeled in abstract terms by business-oriented users who have a good business knowledge and understanding of the various roles in the organization, but who are not necessarily familiar with the details of the Information Technology (IT) services that will ultimately be used to implement the processes in the SOA. Business-oriented users typically use a language such as Business Process Model and Notation (BPMN) to describe a business process. This language contains elements such as “activity,” “gateway,” “signal,” and “flow”. Users often describe their BPs by assigning textual labels such as “payment” or “customer registration” to the generic BPMN elements. Once the business process descriptions are created, a BPMN editor enables users to assign roles from the organization's hierarchy to human activities, to generate forms for manual tasks, to write business rules in scripting languages to condition various execution flows as well as to connect certain tasks to SOA services, among other features.

In contrast to the business-oriented users who design the BPs, the users who design and create SOA services are typically architects and developers with much less business knowledge but who are aware of the SOA functionality available to fulfill the business applications. This creates a disconnect between the business process and the SOA which is solved through a manual “glue” in the form of SOA connectivity parameters in the BP descriptions. This connectivity typically translates into configuration forms that are associated with certain BPMN activities. Filling them in may be aided in some cases by semi-automatic configuration tools which allow users to select appropriate services from a variety of SOA services. This is a manual, top-down approach, because it starts with the business process (the “top”) and connects the activities to the services manually. U.S. patent application Ser. No. 13/410,691, entitled DEPLOYMENT OF BUSINESS PROCESSES IN SERVICE-ORIENTED ARCHITECTURE ENVIRONMENTS, to Jacquin and Mos, filed Mar. 2, 2012, discloses methods of deploying business processes in different SOAs automatically, and is hereby incorporated by reference in its entirety.

Once BPs have been designed and fully configured, they can be run by the BPMS. The BPMS manage their execution and also direct SOA calls to the appropriate SOA services, as required. It would be useful to be able to extract information related to the execution of the BPs to determine whether the various activities execute correctly, their execute time, what data is passed between services, and whether pre-established thresholds for various parameters are exceeded. Currently, some information on the BPs is extracted using a monitoring infrastructure that connects to the BPMS and collects data as the BPs execute. Similarly, for SOA data collection, a monitoring infrastructure can obtain information from the execution environment, such as a specific enterprise service bus.

A problem with business process monitoring is that the techniques generally use generic tools to provide separate monitoring of business processes and services. Because these tools are generic and not specific to business domains, they do not provide details of business concepts in the business processes and do not provide an automatic mechanism to correlate business processes with services. For example, monitoring data may be collected for basic elements such as “activity,” “gateway,” “signal,” and “flow” with no correlation to the business concepts of “payment” and “customer registration,” apart from the simple matching of the textual labels to the monitored generic elements. As a consequence, it is hard to make use of the monitoring data in order to present meaningful metrics to business users, without significant configuration efforts for each BP. This is because simply assigning a label such as “payment” to an “activity” element does not account for other text labels, such as “Process Pay”, “pay”, “pre-payment” or “Pay12,” which may be related to the same concept but not correlated automatically. While this could be addressed by manually selecting monitoring information by a business user, this could be time-consuming.

It is also difficult to correlate the execution of business concepts to the execution of services in the SOA layer. Although some monitoring systems can show that a service was called when executing a particular activity, the generic approach to monitoring means that a particular concept does not invariably entail the execution of a particular set of SOA services. While such data could be extracted with post-mortem analysis techniques on the execution logs, this is slow, manual and cumbersome and does not allow real-time reaction to events (such as enforcing the rule that a particular service may not exceed a given execution time when called in the context of the execution of a particular business concept, while allowing it to exceed this time when running in the context of another concept).

It is also difficult to establish wide-ranging service-level-agreements (SLA) that affect all BPs equally. For example, it may be desirable to specify that all “payment” operations, regardless of the BP in which they occur, are to execute in less than 20 seconds. This could be addressed by manually changing each of the BPs in which the payment activity occurs in order to establish this SLA, or refactoring all BPs to use the “payment” activity as a sub-process and then setting the SLA to the sub-process. This would be time consuming to implement with each new BP.

In addition, the existing frameworks are typically technology-dependent, so when companies migrate their applications to other platforms, the monitoring infrastructure also has to be migrated.

There remains a need for a system and method for monitoring of business processes and their execution.

### BRIEF DESCRIPTION

In accordance with one aspect of the exemplary embodiment, a computer—implemented business process monitoring system includes a set of concept probes. Each of the concept probes is communicatively connected to a monitoring component of an associated business process management suite and is communicatively connected to a monitoring component of an associated service oriented architecture. Each concept probe corresponds to at least one activity of a business process implemented by the business process management suite. The concept probe acquires activity information from the monitoring component of the associated business process management suite about the respective at least one activity and acquires service information from the monitoring component of the associated service oriented architecture about at least one service that is called by the at least one activity. The concept probe generates monitoring information based on at least one of the activity information and the service information. A processor implements the set of concept probes.

In another aspect, a computer-implemented method of monitoring a business process includes, for each activity of a business process, providing a respective concept probe implemented by a computer processor. The concept probe is communicatively linked to a first monitoring component which monitors activities of the business process during execution of the business process by a business process management suite. The concept probe is communicatively linked to a second monitoring component which monitors a service oriented architecture, the service oriented architecture including a plurality of services that are called upon by the activities of the business processes. The concept probe is provided with a mapping between the respective activity and at least one service of the plurality of services that is called on by the activity. During execution of the business process, with the concept probe, activity information about the respective activity is received from the first monitoring component and service information about the called at least one service is received from the second monitoring component. Monitoring information is output from the concept probe based on the received activity information and service information.

In another aspect, a monitoring system includes memory which stores mappings between each activity of a business process and services in an associated service oriented architecture configured to implement the respective activity. A probe generator generates a plurality of concept probes based on the mapping, each of the concept probes corresponding to a respective one of the activities in the business process, each concept probe being communicatively linked to a monitoring component of an associated business process management suite which executes the business process and being communicatively linked to a monitoring component of the service oriented architecture. During execution of the business process, each concept probe acquires activity information from the monitoring component of the associated business process management suite about the respective activity, and acquires service information from the monitoring component of the associated service oriented architecture about at least one service that is called by the at least one activity. The concept probe generates monitoring information based on at least one of the activity information and the service information. A processor implements the plurality of concept probes.

### BRIEF DESCRIPTION OF THE DRAWINGS

FIGS. 1A and 1B are functional block diagrams of a monitoring system in accordance with one aspect of the exemplary embodiment;

FIG. 2 is a flowchart illustrating a method of monitoring a business process with concept probes and business process probes in accordance with another aspect of the exemplary embodiment;

FIG. 3 is a functional block diagram of one embodiment of a business process probe connecting to three concept probes which monitor three business activities and their associated services which may be employed in the system of FIGS. 1A and 1B;

FIG. 4 is a functional block diagram of an exemplary concept probe which connects to several monitoring objects which may be employed in the system of FIGS. 1A and 1B;

FIG. 5 is a functional block diagram of another exemplary concept probe showing its sub-components which may be employed in the system of FIGS. 1A and 1B;

FIG. 6 is a functional block diagram of another embodiment of a business process probe showing its sub-components which may be employed in the system of FIGS. 1A and 1B;

FIG. 7 is a functional block diagram of another embodiment of a concept probe, several business processes and their related services, with business activities and services corresponding to the concept probe circled which may be employed in the system of FIGS. 1A and 1B; and

FIG. 8 is a functional block diagram of a business process probe and several business processes, with the circled business process corresponding to the business process probe which may be employed in the system of FIGS. 1A and 1B.

### DETAILED DESCRIPTION

Aspects of the exemplary embodiment relate to a system and method for monitoring business processes including business activities and, in particular, to business processes running in a Business Process Management Suite (BPMS) which calls services running in a Service Oriented Architecture (SOA).

The monitoring system addresses the shortcomings of existing monitoring capabilities for BPMS/SOA applications by adding a monitoring layer on top of existing capabilities, rather than replacing existing capabilities. This helps to ensure compatibility with a wide range of existing systems and platforms. The exemplary monitoring layer is technology-independent. The monitoring system allows monitoring data to be correlated to a specific activity of a business process and/or across a business process. This can improve understanding of how business processes execute and how they can be improved. The monitoring data helps users to understand how execution of the business process is related to the underlying service oriented architecture. The executable services can be correlated to the business process activities and reported in the context of business process monitoring data.

The exemplary monitoring system includes a plurality of concept probes (CPs). The probes are monitoring components corresponding to business concepts. A “business concept” (or simply, concept) is a business step that may be repeated across business processes, and which is executed using the same service(s) in an SOA each time. Each concept probe (CP) monitors the activities corresponding to a single concept. Each business concept may correspond to one or more business activities. Often, one business activity will correspond to only one business concept, particularly if the activity is defined such that it performs the same function across several business processes and uses the same services in each business process. In such a case, there will be one concept probe for the business activity. However, because business activities are only generic entities described in a graphical notation for modeling BPs, e.g., BPMN, business activities having the same name may perform different functions and use different services. The exemplary concept probes provide an aggregated view of both the business activity and the services involved in the execution of a particular business concept. Each concept probe may also aggregate information from other execution layers, such as operating system and network load information. Once the concept probes are created, they are then bound to monitoring capabilities of the existing infrastructure, effectively acting as an extra monitoring layer on top of existing BPMS and SOA monitoring capabilities. In addition to the concept probes, a business process probe (BPP) can be created. Each BPP corresponds to a respective deployed business process and is a composition of the concept probes that correspond to the concepts (and therefore business activities) used in the business process.

The exemplary monitoring system utilizes concept mappings, which are connections between business concepts and the SOA services that are used by them. The concepts can then be used in a variety of BPs in various combinations.

Before deployment of the exemplary monitoring system begins, the following four sets are assumed to be known:
1. The set of services S={s₁, s₂, . . . s_{q}} to be run in the SOA.
2. The set of all business processes P={p₁, p₂, . . . pₘ} to be run in the BPMS.
3. Each business process pₖ in P has a respective set of activities Aₖ={aₖ₍₁₎, aₖ₍₂₎, . . . aₖ₍ₜ₍ₖ₎₎} where t(k) is the number of business activities in pₖ.
4. From set 3, the set of all activities in all the business processes can be constructed: A=A₁∪A₂∪ . . . ∪A_{|P|}.

Business activities may be repeated in different processes, but the concept mapping need only be performed once per activity.

The concept mapping operations are designed to determine the following four sets:
5. The set of concepts C={c₁, c₂, . . . cₙ}.
6. For each concept, a set of the predefined services: CM={(cⱼ, Sⱼ): ∀CⱼεC; Sⱼ⊂S}. Note that each concept can map to one, two, or more services, so an example element of CM could be: (c4, (s1, s3, s8)).
7. For each process pₖ, a set containing, for each activity, the concept that the activity maps to can be constructed: AMₖ={(a_{k,i}, cⱼ): ∀a_{k,i}εAₖ; cⱼ εC}. This mapping is one to one and each activity maps to a single concept.
8. The sets in 7 can be combined (by forming the union of all the sets) to form the set of all activity to concept mappings: AM=AM₁∪AM₂∪ . . . ∪AM_{|P|}. From this set, the exemplary concept probes are built. That is, from this set, each concept probe is assigned those activities in the BPMS that it is to monitor.

The number of activities, services and concepts is not limited, however, in general there are at least two or at least three activities executed in a business process, each activity being executed one or more times. The SOA includes at least two or at least three, or at least four services, and each activity in a business process calls on a different set of the services. In general, no two distinct activities use exactly the same services. Services can include IT services, such as generating or completing electronic forms, automatically sending/receiving payments, generating displayable content for a webpage, and the like.

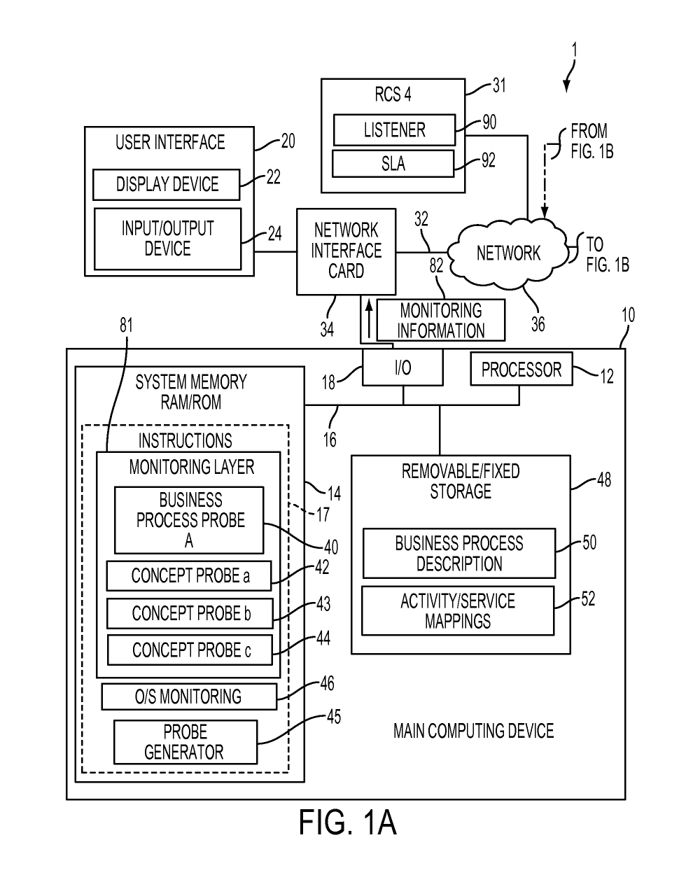

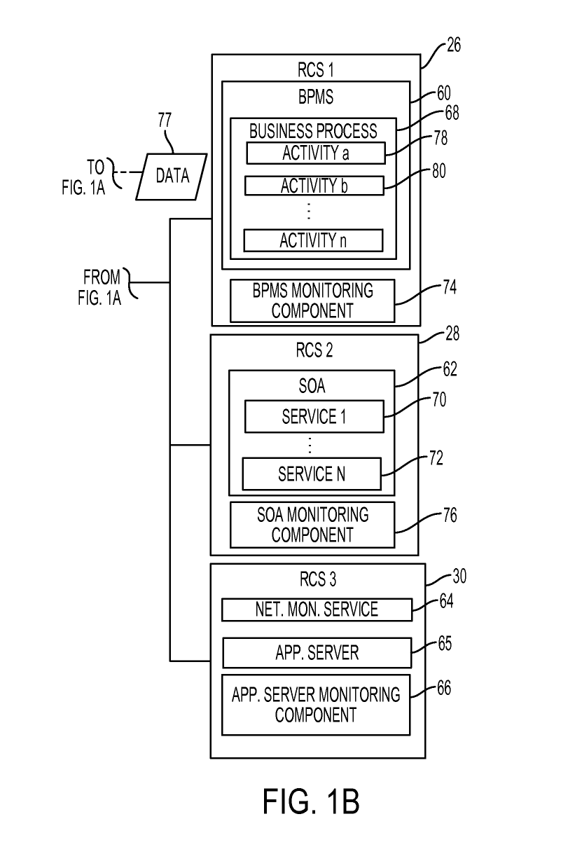

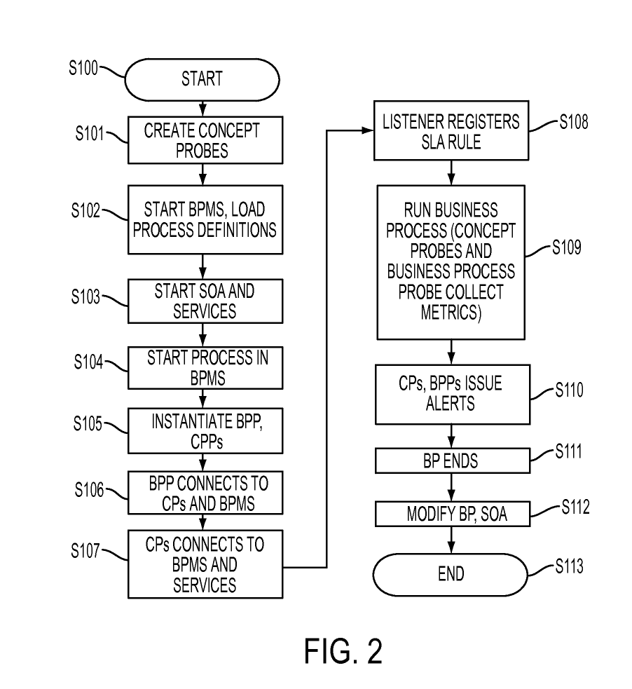

FIG. 1A shows a functional block diagram of a computer-implemented monitoring system 1 suitable for performing the exemplary method disclosed herein. As will be appreciated, separate computer systems may be configured and connected for monitoring and for running individual services, activities, and processes. The illustrated monitoring system 1 includes a main computing device 10 including a processor 12, which controls the overall operation of the computing device 10 by execution of processing instructions which are stored in a memory 14 connected to the processor 12 by a bus 16. The processor 12 also executes instructions 17, stored in memory 14, for performing the exemplary method outlined in FIG. 2.

The monitoring system 1 may include multiple processors 12, wherein each processor is allocated to processing particular (sets of) instructions. Monitoring system 1 also includes one or more interfaces to connect the main computing device 10 to external devices, including an input output (I/O) interface 18. The I/O interface may communicate with a user interface 20. The user interface 20 may include one or more of a display device 22, for displaying information to users, such as an LCD screen, and a user input device 24, such as a keyboard or touch or writable screen, and/or a cursor control device, such as a mouse, trackball, or the like, for inputting instructions and communicating user input information and command selections to the processor. The I/O 18 also links the computing device 10 with external devices, such as the illustrated (see FIGS. 1A and 1B) remote computing systems 26, 28, 30, and 31 via wired or wireless links 32. For example, I/O 18 may include or communicate with a network interface card (NIC) 34 which is in turn connected to a network 36, which links the main computing device to computing systems 26, 28, 30, and 31.

Memory 14 may store instructions 17 for executing various software components, such as a business process probe 40, a plurality of concept probes 42, 43, 44, which may be created at least partially automatically by a probe generator 45, and an operating system (O/S) monitoring service 46. These components may in turn be composed of other components, explained further below. The monitoring system 1 may also include a storage unit 48 which may be removable or fixed. The storage unit 48 may store, for example, data sufficient to load into memory a business process description 50 and activity/service mappings 52.

The main computing device 10 may include a PC, such as a desktop, a laptop, palmtop computer, portable digital assistant (PDA), server computer, cellular telephone, pager, or other computing device or devices capable of executing instructions for performing the exemplary method or methods described herein.

The memory 14 and storage unit 48 may be separate or combined and may each represent any type of non-transitory computer readable medium, such as random access memory (RAM), read only memory (ROM), magnetic disk or tape, optical disk, flash memory, or holographic memory. In one embodiment, the memory 14, 48 comprises a combination of random access memory and read only memory. In some embodiments, the processor 12 and memory 14 and/or storage unit 48 may be combined in a single chip.

The I/O interface 18 communicates with other devices via computer network 36, such as a local area network (LAN), a wide area network (WAN), or the Internet, and may comprise a modulator/demodulator (MODEM). The digital processor 12 can be variously embodied, such as by a single core processor, a dual core processor (or more generally by a multiple core processor), a digital processor and cooperating math coprocessor, a digital controller, or the like.

The term “software” as used herein is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on the server or other location to perform certain functions.

With reference to FIGS. 1A and 1B, the remote computing systems 26, 28, 30, and 31, which may be separate or combined, may be similarly configured to the main computing device 10, i.e., may include memory and a processor.

One or more of the remote computing systems (RCS 1) 26, may provide access to a business process modeling suite (BPMS) 60 which implements the business process description 50 by running a business process 68. The BPMS 60 may include an execution engine for executing Business Process Execution Language (BPEL) scripts, or another type of runtime engine. Another of the remote computing system(s) (RCS 2) 28, may provide access to a Service Oriented Architecture 62, providing the BPMS processes with access to services that execute the business process. Another of the remote computing system(s) (RCS 3) 30, may provide access to monitoring services, such as a network monitoring service 64 and/or application server monitoring service 66. The BPMS 60 includes a BPMS monitoring component 74 which monitors activities 78, 80, etc. The SOA 62 includes an SOA monitoring component 76 which monitors services 70, 72, etc. The BPMS monitoring component 74 and SOA monitoring component 76 provide monitoring data 77 to the business process probe 40 and concept probes 42, 43, 44 via network 36. A remote computing system (e.g., RCS 3, 30) may include an application server 65 which presents a user interface (e.g., a webserver) to the users of the business process, allowing them to, for example, fill in forms or mark activities as complete.

The monitoring framework of FIGS. 1A and 1B provides a further monitoring layer 81 on top of the BPMS monitoring 74 component and SOA monitoring component 76 that includes a set of concept probes 42, 43, 44. Rather than relying on generic mechanisms to provide monitoring data, the monitoring layer 81 uses the concept probes to provide monitoring information 82. The concept probes match the business concepts used in the definition of the business activities which form the business processes. The concept probes combine monitoring information from business process execution as well as service execution into aggregated information that is informative from a business concept point of view. This aggregated information 82 may be accessed by a listener component 90, which in turn can be accessed by a person via a user interface, such as interface 20. The listener component may evaluate compliance of the monitoring information with one or more rules, such as a service level agreement (SLA) rule 92. In one embodiment, the listener component may communicate the rule 92 to the business process probe 40 and/or a concept probe 42, 43, 44. The listener component registers the SLA rule 92 with the probe and receives/outputs an alert if the SLA rule 92 is violated.

This monitoring approach provides several advantages. First, it provides a much better understanding of the various execution parameters of the business concepts used in processes (including performance, correctness, and context). Second, it helps with setting application-wide alarms and constraints potentially corresponding to Service-Level-Agreements, on a concept-level. For a given concept, such constraints can be set-up with immediate effect in all the business processes that use the concept. Third, this approach gives technical users a deep understanding of the contribution of each of multiple application layers (BPMS, SOA, OS, etc.) to the combined performance of a particular business concept. This can lead to rapid deployment of modifications to particular services, changes in business partners (that provide better services) or improvements in the underlying infrastructure or application parameters.

U.S. patent application Ser. No. 13/410,691 describes a method of deploying business processes in an SOA, which may be utilized by the monitoring system 1, so that the definition of the deployment artifacts may assist with the definition of the concept probes.

Once the business processes are designed and fully configured, they can be run by the BPMS 60. The BPMS 60 manages their execution and also directs SOA calls to the appropriate SOA services (e.g., services 70, 72). The monitoring system is able to extract information related to the execution of the business processes. Such information can be used to understand what happens with the various activities 78, 80, etc., whether they execute correctly or not, how long it takes to execute them, what data is passed, and whether pre-established thresholds for various parameters are exceeded or not. Such information is extracted using the concept probes 42, 43, 44 that connect to the BPMS monitoring component 74 and collect data as the business processes execute. The concept probes may be configured to interface with the BPMS monitoring component 74. Similarly, for SOA data collection, the concept probes can connect to the SOA monitoring layer 76 using, for example, a specific Enterprise Service Bus to collect metrics of interest.

With reference to FIG. 2, a method for monitoring execution of a business process is illustrated. The method is at least partially computer implemented. The method begins at S100. At S101, concept probes 42, 43, 44 are created by the probe generator 45, which includes mapping business concepts to the services that implement them. The concept probes 42, 43, 44 may be aggregated to form a business probe 40 corresponding to a given business process.

The exemplary concept probes 42, 43, 44 provide a significant benefit when the business concepts are reused repeatedly in the business processes, including re-use of the same services in the SOA by the same business concept. For example, the concept “payment” may be identified as being used in various business processes. Such a concept may require a number of SOA services in order to be executed, and these services are identified and correlated to the concept of “payment.” If different business processes use a concept of “payment,” but these concepts do not share the same services, this may indicate that the “payment” concept is in fact several different concepts, and the concept of “payment” has not been consistently used in the business processes. A similar problem may arise when a “payment” task is spread across two business activities, which use the same services collectively as another single activity “payment” task, but, because the “payment” task is spread over two activities it may not be identified and correlated to the other “payment” business activities. These misidentification problems can result in activities that should be correlated to the same concept not being correlated, resulting in redundant work and redundant business concepts. Alternatively, activities may be correlated when they should not be, resulting in a business concept that essentially implements two separate activities, being needlessly complex with little gain.

There are several methods for identifying the activities and services that correspond to a particular business concept. One approach, which is an automatic top-down method, is useful for organizations that will create new business processes in the future. It assumes that the concepts are defined by business experts and eventually bound to SOA services in a deployment stage where their service requirements are mapped to available SOA assets, as described, for example, in U.S. application Ser. No. 13/410,691. Because the services are mapped at the deployment stage, the service mappings used by each concept can be automatically generated.

Another approach, which is an automatic bottom-up method, uses existing legacy BPs which are already deployed and functional in an organization. This approach is best suited for existing BPs deployed in BPMS/SOA environments. In this approach, mappings of services are extracted from execution logs to cluster and identify commonly used concepts and their correlations to SOA services.

Yet another approach, which is a manual top-down method, is similar to the first approach (Automatic Top-Down), and it can be applied in organizations that do not use a deployment stage for BPs that connects them automatically with the SOA. It has the same characteristics as the first approach but it entails the manual annotation of concepts with SOA services, rather than using the service binding information that the first approach has.

The three approaches can be used in combination in some cases, for instance, the Automatic Bottom-Up method may obtain help from a Manual Top-Down approach to increase quality of the results.

The result is set #6, described above: for each concept, a set of services: CM={(cⱼ, Sⱼ):∀cⱼεC; Sⱼ⊂S}.

After the concepts and their corresponding services are identified, the business processes (existing or future) are then mapped to the concepts. This involves matching each business activity to a concept, constructing sets #7 and #8, described above. Such matching is closely related to the method for identifying concepts. When using the Automatic Top-Down method, the business processes are composed of activities directly matching concepts, so there is no ambiguity, each activity corresponds to a clearly identified concept. When using the Automatic Bottom-Up method for identification, the concepts are extracted from business activities, so matching activities to concepts entails simply storing the correlations between the activities and the extracted concepts. When the Manual Top-Down approach is used, BPs are annotated with the concepts manually, which entails the manual creation of the connection between activities and concepts.

The creation of concept probes 42, 43, 44 thus includes identifying, from existing business processes, concepts corresponding to each business activity, identifying the services the concept uses, configuring the concept probe to retrieve data from the BPMS monitoring layer 74 about the corresponding business activity, and configuring the concept probe to retrieve data from the SOA monitoring layer 76 to retrieve data from the relevant services. Once the concept probes 42, 43, 44, etc., have been created (manually or automatically), the method proceeds to S102.

At S102, the BPMS 60 is started and the business process descriptions 50 are loaded into memory.

At S103, the SOA 62 is called on. The services including services 1 70 through N 72 may be started when the SOA is called on or, alternatively, the services may be started on demand.

At S104, a business process 68 is started. The request to begin the business process may be initiated by a request from, for example, the application server 65.

At S105, the business process probe 40 and concept probes 42, 43, 44 are loaded into the BPMS memory, or instantiated (if they have not already been instantiated). As will be appreciated, the business process probe and concept probes may be loaded at another suitable time, e.g., when the BPMS is started or beforehand. Alternatively, the probes may be activated when a business process is started and need not be loaded for subsequent occurrences of the same process, as all instances of the same process use the same business process probe. Similarly, all instances of the same activity, even from different processes, may use the same concept probe. Alternatively, there may be multiple instances of each concept probe, each concept probe instance corresponding to one of the activity instances. It is also anticipated that the processes may be started and later collected, if the processes are unused for a period of time.

At S106, the business process probe 40 connects to the BPMS monitoring component 74 and individual concept probes which correspond to the activities of the corresponding business process 68. As with the instantiation step S105, if the business process had already run or if all probes are started when the BPMS is started, the probes would already be connected.

At S107 the concept probes 42, 43, 44, etc., connect to the BPMS monitoring component 74 and SOA monitoring component 76. The concept probes may subscribe to or otherwise request information about each activity corresponding to the concept probe, and may have multiple connections to the BPMS monitoring component 74. Similarly, each concept probe may request information from SOA monitoring component 76 for each service that the concept probe is to monitor. Additionally, each concept probe may have a unique process ID and/or activity ID, to identify which data was generated by which instance of an activity.

At S108, the listener component 90 registers for alerts. The alerts may be generated from the service level agreement rule 92.

At S109, the business process runs in the BPMS, which sends monitoring data 77 to the concept probes and business process probes via the BPMS monitoring component 74. As services 70, 72, etc., are called by the business activities, the SOA 62 collects and sends monitoring data 77 to the concept probes and/or business process probes via the SOA monitoring component 76.

The concept probes and/or business probes receive the data 77 compute metrics based thereon, evaluate compliance of the metrics with the rules 92, and output information 82 based thereon. For example, if the rules are violated, then, at S110, the concept probe or business process probe that detected the violated rule (e.g. SLA rule 92) issues an alert to all subscribed listener components 90.

At S111, the business process ends.

At S112, modifications may be made to the BP and/or SOA to obtain compliance, or closer compliance, with the SLA. 92. This step may be at least partially manually implemented.

At S113, the method ends.

Further details of the system and method will now be provided.

### Exemplary System Architecture

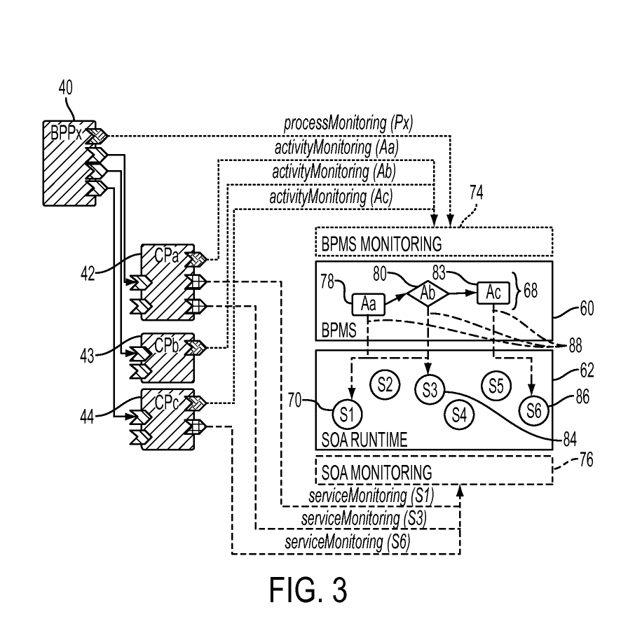

FIG. 3 illustrates a simple example business process 68 deployed into the BPMS 60 and connected to the services (e.g., 70) in the SOA 62 by links from activities Aa 78, Ab 80, and Ac 83. In particular, activity Aa 78 employs services S1 70 and S3 84, Ab 80 employs S3 84, and Ac 83 employs S6 86. This simple example is meant to illustrate the relationship between the concept probes, business process probes, the BPMS, and the SOA. An actual business process may have many more business activities, and a BPMS may host several business processes. The links 88 represent regular web service calls such as Simple Object Access Protocol (SOAP), which is XML based, or Representation States Transfer (REST)ful invocations.

The BPMS monitoring 74 is provided by the BPMS 60 and generally includes capabilities such as the generation of events when activities execute, the computation of execution times for activities, and the reporting of various states in which the business processes operate. The SOA environment may be an Enterprise Service Bus or other form of SOA-based middleware such as an SCA runtime (e.g., Apache Tuscany). The SOA monitoring component 76 may include capabilities for monitoring the service invocations, computing execution times for various service operations and reporting of the states in which the services operate.

As shown in FIGS. 1A and 1B, other monitoring layers may be available in an enterprise environment, such as operating system monitoring 46 or network monitoring 64. Other monitoring may be available, such as cloud monitoring, not shown.

FIG. 3 illustrates three concept probes, CPa 42, CPb 43, and CPc 44, which correspond to the business concepts a, b and c, used in the illustrated business process 68 through the activities Aa 78, Ab 80, and Ac 83. In addition to the CPs, a business process probe 40 is illustrated. This corresponds to the example business process 68 and uses the three concept probes 42, 43, 44 to aggregate business process information. The outgoing lines from the concept probes 42, 43, 44 represent their connections to the BPMS monitoring component 74 and SOA monitoring component 76. For example, since CPa 42 is a probe specifically generated for concept a, it will interrogate the BPMS monitoring system 74 with regard to the activity Aa 78 and the SOA monitoring system 76 with regard to services S1 70 and S3 84. These connections are generated based on the knowledge that concept a is used in activity Aa 78 and requires services S1 70 and S3 84. This knowledge comes from the concept mappings generated at design time. The lines linking the probes are labeled with abstract functions to illustrate what type of data they collect from monitoring components 74, 76. The chevrons indicate data inputs to the probes that are provided by the links. Thus, for example, the concept probes receive data inputs form the monitoring systems 74, 76 and the business process probe can exchange information with the concept probes.

The concept probes leverage existing monitoring capabilities using specific bindings related to the concepts (and therefore related to the business activities) they need to match. They aggregate data from the BPMS monitoring component 74, the SOA monitoring component 76, and optionally other monitoring systems (e.g., O/S monitoring 46 and Application Server Monitoring 66) into meaningful information that matches the business concepts used throughout a business process 68. Similarly, the BPPs 40 aggregate the monitoring data from concept probes corresponding to the monitored business process with additional business process specific monitoring information that is generated by the BPMS monitoring component 74, such as timestamps, duration for the process execution, user roles, and other process-specific data. The information provided by a business process probe may thus be significantly richer than that provided by BPMS monitoring systems for a given business process because it includes the breakdown of monitoring information for each of the business activities used in the business process as well as the aggregated business process level data. BPMS monitoring systems can make the correlation between a business process and its corresponding business activities, but the exemplary business process probes and concept probes can consolidate monitoring information in a monitoring system that is aware of the services used by the business activities, providing more data than simply presenting monitoring data based on activity names from business process modeling notation types.

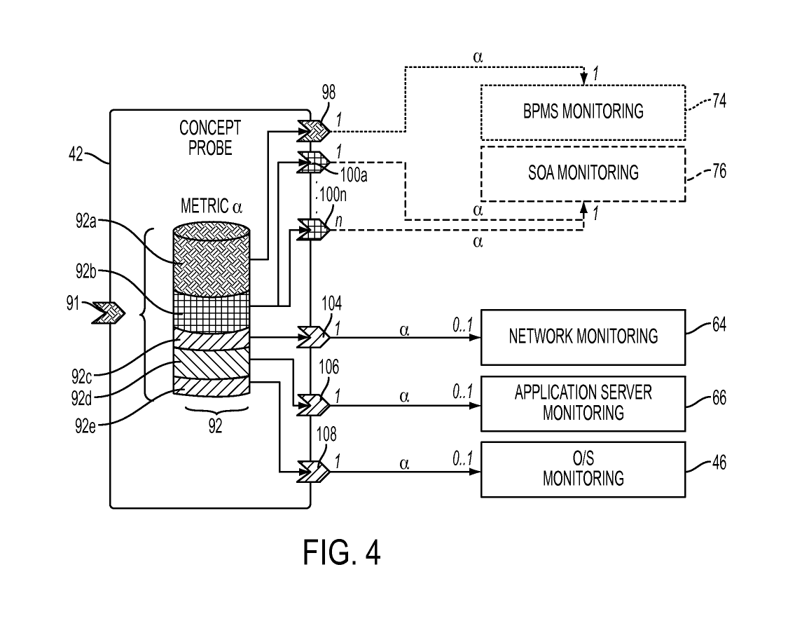

FIG. 4 illustrates a concept probe's interaction with other components of the system 1. The exemplary concept robes are capable of collecting and measuring several metrics, such as execution time and/or execution status. For illustration purposes, execution time is used as an example, and metrics are identified by Greek symbols such as metric α. FIG. 4 shows a simplified representation of concept probe 42, where only one collected metric α92 is given as an example. Several metrics can be extracted by the same concept probe.

FIG. 4 illustrates that in order to compose metric α 92, metric α data is collected from individual monitoring systems 74, 76, 64, 66, 46 and then aggregated within the probe 42. The resulting monitoring information may be eventually exposed to clients of the probe via an interface 91. Clients of the probe may include the business process probe 40 (see FIG. 3) and/or listener component. FIG. 4 also shows the multiple connections to the monitoring systems, including a single BPMS monitoring connection 98, several outgoing connections 100a . . . 100n to the single SOA monitoring system 76, as well as optional connections to other monitoring systems that are relevant for the given metric. The multiple connections to SOA monitoring system 76 are to monitor the multiple services associated with concept probe 42.

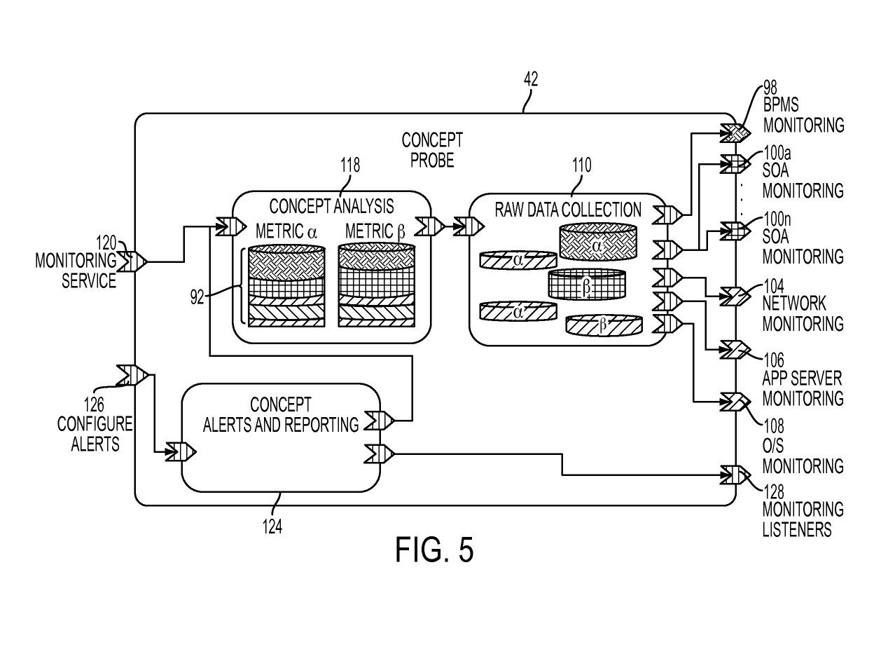

Each of the concept probes 42, 43, 44 may include the same principal components, which are illustrated in FIG. 5. A first component, or Raw Data Collection component 110, collects data for a given metric from the collection inputs. Each concept probe has several corresponding data collection inputs: including one BPMS monitoring point 98, several SOA collection points 100a . . . 100n, an operating system (O/S) collection point 108, network collection points 104, and an application server monitoring point 106. The example is illustrative only, and a concept probe may have several network or O/S monitoring interfaces if, for example, the business process and services communicate across several networks.

The BPMS monitoring point 98 collects data from the BPMS 60 (FIG. 1B) about the activities that map to the concept probe 42, more formally: CAj={axy: (axy, cj)εAM} where AM is the activity to concept mapping, described above. In the exemplary system, there is one concept probe per concept regardless of the number of activities that correspond to a given concept. One reason for this is that the method emphasizes the value of monitoring each individual concept regardless of where it is used in the business processes. So each time an activity is executed, the concept probe corresponding to the concept associated with the activity is notified.

The several SOA collection points 100a . . . 100n each map to the SOA Runtime monitoring capabilities for one of the SOA services that the concept maps to, i.e., set Sⱼ in the concept to services map (set #6), described above. These points extract execution information for the services that are related to the concept.

The several other optional collection points may collect information to be correlated with the information from the above-mentioned collection points. This includes network monitoring 104, application server monitoring 106, and operating system monitoring 108. These extra collection points can give useful information regarding the context of the metric values. For instance, a service execution can be considered to be slow if network latency is very high. Similarly, if the OS processes are not scheduled properly by the OS or if the application server is not scalable, these can impact the execution of the BPMS and the SOA layers. Therefore, these extra collection points can potentially be very useful, although they are not essential. They are given here as an example of extra aggregation capabilities of the probes.

As shown in FIG. 5, a second component of each concept probe is a concept analysis component 118, which aggregates raw data obtained from the collection component 110 into composite metrics (e.g., into metric α92). These composite metrics are data structures that present the aggregate monitoring information combining the individual metric data for the BPMS, SOA and other collection points, for the concept. The data structures may give an aggregate value if appropriate (such as total execution time), as well as a breakdown of this value or contextual information pertaining to this value for the individual collection points. This can include the individual execution time of services and of the process activity in the BPMS 60, as well as values for network latency, resource utilization in the application server or process scheduling in the operating system. Similarly, cloud-related data can be obtained such as the virtual machine utilization for the server executing the SOA services or BPMS elements. Individual methods for obtaining these values are specific to individual monitoring frameworks. For at least one of the concept probes, the computed metric α or β is based on acquired monitoring data from both the SOA and the BPMS. The concept analysis component 118 may also be queried by outside clients for metric values via the monitoring service port 120 of the concept probe 42.

A third component of the concept probe 42 of FIG. 5 is a concept alerts and reporting component 124 which provides specific reports about the execution of the concept and alerting rules to registered listener components. Reporting component 124 allows the registration of service-level agreement (SLA) requests through a configure alerts port 126 and uses the concept analysis component 118 to compare aggregated metric values with the thresholds of the SLA. Ports 120 and 126 were represented in a simplified manner as aggregated port 91 in FIG. 4. If the SLA thresholds are not met (e.g., exceeded in the case of execution time), the alerting component 124 may notify registered monitoring listener components via listener port 128. These listeners are external entities which can be connected to the monitoring probe and be notified of important alerts and events through alert port 128.

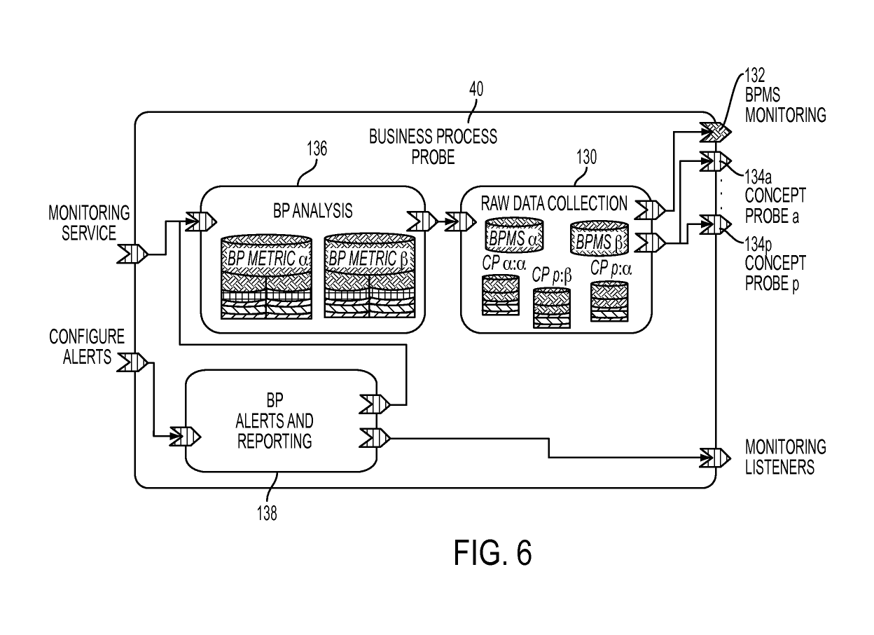

FIG. 6 illustrates the components of an exemplary business process probe 40. There is exactly one business process probe per business process deployed. If multiple instances of the same business process are started, all can be monitored by the same BPP. Similar to concept probe 42 (FIG. 5), the business process probe 40 includes three components. Specifically, the BPP 40 includes a raw data collection component 130 which collects monitoring data from the concept probes 42, 43, 44 that correspond to the activities of the business process monitored by BPP 40. BPP 40 has one BPMS collection point 132 and several connections 134a . . . 134p, one to each of the concept probes. The BPMS collection point 132 collects monitoring data for the execution of a corresponding business process in the BPMS 60. This can include contextual information (e.g., user name) for the required metric as well as metric values for the business process (e.g., execution time of the business process as seen from the BPMS). The several connections connect to each of the concept probes that are used for the business process. These concept probes correspond to the set of process concepts PCₖ={cᵢεC:∀(aₖₓ, cᵢ)εAMₖ} where AMₖ is the mapping from concept to activity mapping described above in set #7. These are used in the aggregation of monitoring data corresponding to each concept used by the business process. If a concept appears several times in the process (due to several of the process activities mapping to the same concept), then this concept will count several times in the aggregation. This is part of the logic of a business process analysis (BP analysis) component 136.

The BP analysis component 136 is very similar in functionality to the concept analysis component 118 of the concept probe 118, except that it aggregates data from the BPMS (for the whole process) and the various concept probes, rather than from BPMS (for each activity), the SOA, and the extra monitoring collection points. To this end, it aggregates the BPMS collected data corresponding to the execution of the process together with the already aggregated data of each of the CPs to which it connects. The CPs correspond to monitoring data for the individual activities that compose the process so they are illustrated side by side horizontally, under the complete process data. An example BP metric is the complete execution time of a process, that is composed by the sum of the individual execution times of its activities. It may be very useful to understand why a process executes in a given amount of time, and the composed metric may be able to show its individual components, highlighting the concepts that take the most amount of time. This can be decomposed even more by showing why the individual concepts take that long to execute, by identifying the individual services that are used for the concepts as well as the other monitoring data collected.

A third component of the BP probe is a BP alerts and reporting component 138. This has a similar function to the concept alert and reporting component 124 of the concept probe, except that it refers to the entire business process.

### Probe Generation (S101)

As discussed above, BPPs and CPs can yield maximum benefits when generated automatically, particularly when using automatic top-down generation, which uses knowledge about the set compositions. Once the sets are obtained, the probes are able to be created, instantiated, and deployed.

The generation can be done using a variety of existing methods such as code generation, template instantiation, and/or component generation. Once they are generated, they can be executed as running entities managed by a monitoring framework. A variety of monitoring frameworks exist that can be used for managing the probes, and the monitoring probes can be executed in any extensible monitoring system. As such, their deployment can be monitoring-system dependent while their generation is system-independent.

The instantiation of the actual CPs and BPPs and their usage in an existing monitoring framework may be monitoring-system dependent. The instantiation of the actual CPs and BPPs and their usage in an existing monitoring framework is also monitoring-system dependent.

A common standard for connecting with and extension of monitoring systems is the Java Management Extensions (JMX) standard. This allows the use of standardized elements called MBeans to complement and interface with the data collection and control capabilities of a monitoring system. Commercial monitoring systems may employ JMX to connect to third-party constructs, such as the business process probes and concept probes, although JMX is not the only option to connect to existing monitoring frameworks. If using JMX, probe generation may employ the generation of Java classes for concept probes and business process probes, exposing these classes as MBeans using specific mechanisms described in the JMX specification. In addition, it would imply connecting these generated MBeans to existing MBeans that represent the legacy monitoring capabilities of the BPMS, SOA, and any other layers.

Existing monitoring solutions are typically technology-specific and generic with respect to the business domains. In contrast, the approach presented here is generic with respect to technology and domain-specific with respect to the business.

Having monitoring probes, such as the exemplary concept probes and business process probes, gives insight into the execution of applications. Business users can understand how the processes execute in terms that are ideally suited to them. In addition, they can specify constraints and alerts for particular concepts that have immediate effect across the entire spectrum of the deployed business processes.

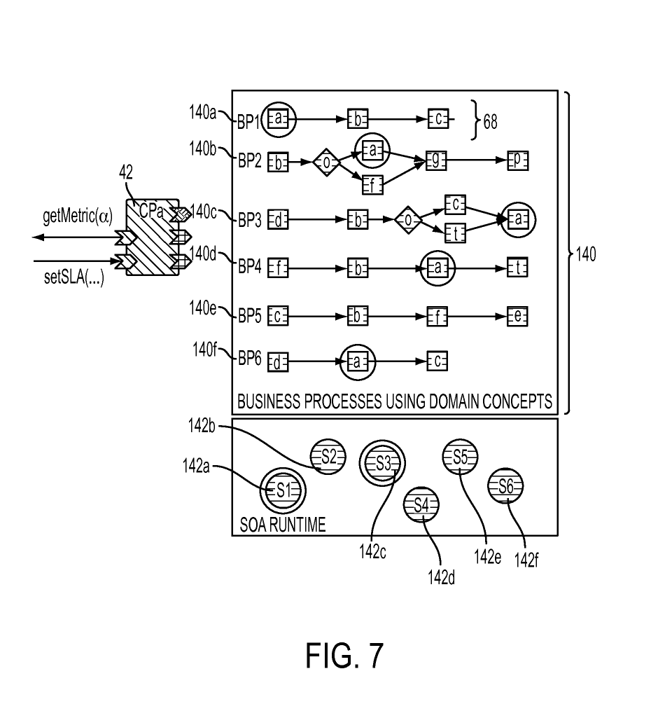

FIG. 7 illustrates the impact of a single concept probe in a set 140 of deployed business processes that make use of the respective concept (concept “a” in the example). Setting a service-level agreement for the concept may translate into the constraint being applied to all the activities of all the business processes using it (e.g., business processes 140a, 140b, 140c, 140d, and 140f). Similarly, specifying alerts or simply observing the concept behavior can be applied to any execution of the activities related to “a”. In addition, each execution monitoring of such activities can be complemented by monitoring of the SOA services that are associated with the concept (e.g., services 142a and 142c). Besides performance metrics, this approach can bring useful benefits in understanding whether a concept executes successfully.

For technical users or system administrators, the system may provide a breakdown of responsibilities for performance problems showing the individual contribution of each of the layers involved and each of the entities (e.g., services) that compose the concept execution.

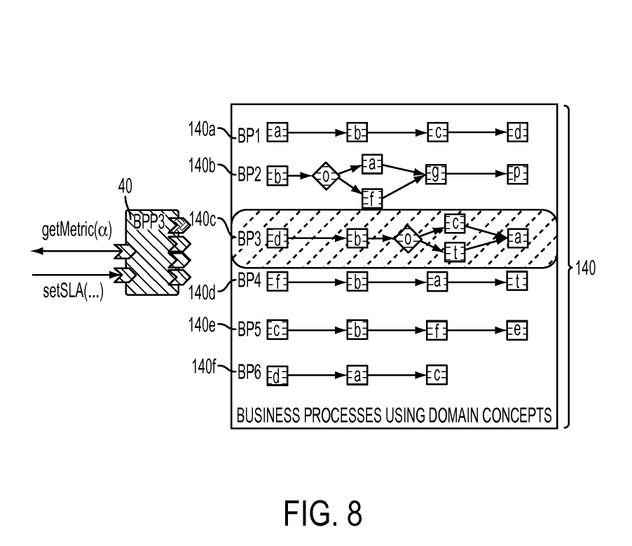

Similarly, when monitoring process execution, this approach promotes the use of process-level probes composed of concept probes. FIG. 8 shows business process probe 40 corresponds to a business process BP3 140c. Accordingly, it may provide the same information as described above, but at the process-level. Therefore business users could understand how a process performs in terms of the business concepts that it includes, while technical users could understand the impact of the various layers and entities involved to fulfill the end-to-end process. This can help pinpoint SOA services (not shown in the image) that cause bottlenecks for individual processes, or explain why certain processes do not execute correctly, by showing the concepts whose execution fails.

The method illustrated in FIG. 2 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 2, can be used to implement the method.

As will be appreciated, the steps of the method need not all proceed in the order illustrated and fewer, more, or different steps may be performed.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A computer-implemented business process monitoring system comprising:
a set of concept probes, each of the concept probes being communicatively connected to a monitoring component of an associated business process management suite and also being communicatively connected to a monitoring component of an associated service oriented architecture, each concept probe corresponding to at least one activity of a business process implemented by the business process management suite, the concept probe acquiring activity information from the monitoring component of the associated business process management suite about the respective at least one activity, and acquiring service information from the monitoring component of the associated service oriented architecture about at least one service that is called by the at least one activity, the concept probe generating monitoring information based on at least one of the activity information and the service information; and
a processor which implements the set of concept probes.

2. The system of claim 1, wherein the concept probe is configured for receiving a rule and the monitoring information comprises an alert provided to a listener component when the rule is violated.

3. The system of claim 2, wherein the rule comprises a threshold execution time for the at least one activity corresponding to the concept probe and the alert is generated when the threshold execution time is not met.

4. The system of claim 1, wherein the business process is defined in business process model and notation (BPMN).

5. The system of claim 1, wherein the concept probe receives at least one of service information and activity information from an associated network monitoring service.

6. The system of claim 1, wherein the concept probe comprises:
a raw data collection component that receives the activity information from the BPMS monitoring component and the service information from the SOA monitoring component;
an analysis component that analyzes the activity information and service information to detect if a registered rule is violated; and
a concept alerts and reporting component that generates an alert based on a detected rule violation and sends the alert to at least one associated registered listener component.

7. The system of claim 6, wherein the raw data collection component further receives monitoring data from at least one of a network monitoring component, an application server, and an operating system monitoring component.

8. The business process monitoring system of claim 1, further comprising:
a business process probe communicatively connected to the set of concept probes to receive probe data and to the monitoring component of the associated business process management suite to receive process information, the business process probe configured for generating alerts based on at least one of the probe data and the process information.

9. The system of claim 8, wherein the business probe is configured for receiving a rule and the monitoring information comprises an alert provided to a listener component when the rule is violated by the business process.

10. The system of claim 8, wherein the rule includes a threshold execution time for the business process.

11. The system of claim 1, wherein the business process probe comprises:
a raw data collection component that receives probe data from the concept probe and receives process information from the monitoring component of the associated business process management suite;
a business process analysis component that analyzes the probe data and process information to detect if a registered rule is violated, and
an alerts and monitoring component that generates an alert based on a detected rule violation and sends the alert to at least one associated registered listener component.

12. The system of claim 1, wherein the associated business process management suite implements the business process as a first business process and implements a second business process which comprises a second activity which corresponds to the same concept probe as the at least one activity of the first business process, and the concept probe receives activity information from the monitoring component of the associated business process management suite about the at least one activity of the first business process and the second activity of the second business process.

13. A computer-implemented method of monitoring a business process comprising:
for each activity of a business process, providing a respective concept probe implemented by a computer processor;
communicatively linking the concept probe to a first monitoring component which monitors activities of the business process during execution of the business process by a business process management suite;
communicatively linking the concept probe with a second monitoring component which monitors a service oriented architecture, the service oriented architecture including a plurality of services that are called upon by the activities of the business processes;
providing the concept probe with a mapping between the respective activity and at least one service of the plurality of services that is called on by the activity;
during execution of the business process, with the concept probe, receiving activity information about the respective activity from the first monitoring component and receiving service information about the called at least one service from the second monitoring component; and
outputting monitoring information from the concept probe based on the received activity information and service information.

14. The method of claim 13, further comprising:
providing a business process probe for the business process;
during execution of the business process, with the business process probe, receiving monitoring information from each of a plurality of the concept probes; and
outputting process monitoring information based on the received monitoring information.

15. The method of claim 14, further comprising:
with the business process probe, receiving at least one of process-related activity information from the first monitoring component and process-related service information from the second monitoring component; and
wherein the process monitoring information is also based on the at least one of the process-related activity information and the process-related service information.

16. The method of claim 13, further comprising computing a metric based on the received activity information and service information.

17. The method of claim 13, wherein the outputting of monitoring information comprises outputting an alert when a metric that is computed based on the received activity information and service information does not meet a predetermined threshold for the metric.

18. The method of claim 13, further comprising:
registering a rule and a listener component with the concept probe, the listener component receiving an alert if the registered rule is violated.

19. The method of claim 18, wherein the rule establishes a threshold execution time for executing the at least one activity by the at least one service of service oriented architecture.

20. A non-transitory computer readable medium storing instructions which when executed by a computer processor, performs the method of claim 13.

21. A system comprising memory which stores instructions for performing the method of claim 13 and a processor in communication with the memory for executing the instructions.

22. A monitoring system comprising:
memory which stores mappings between each activity of a business process and services in an associated service oriented architecture configured to implement the respective activity;
a probe generator which generates a plurality of concept probes based on the mapping, each of the concept probes corresponding to a respective one of the activities in the business process, each concept probe being communicatively linked to a monitoring component of an associated business process management suite which executes the business process and being communicatively linked to a monitoring component of the service oriented architecture,
during execution of the business process, each concept probe acquiring activity information from the monitoring component of the associated business process management suite about the respective activity, and acquiring service information from the monitoring component of the associated service oriented architecture about at least one service that is called by the at least one activity, the concept probe generating monitoring information based on at least one of the activity information and the service information; and
a processor which implements the plurality of concept probes.
